(19) United States
(12) Patent Application Publication
(10) Pub. No.: US 2006/0096261 A1
(43) Pub. Date: May 11, 2006

(54) Air duct filter assembly with identical and color coded air filter

(76) Inventor: Dong Zhang, Ellicott City, MD (US)

Correspondence Address: Dong Zhang, 7641-A Coachling Lane, Ellicott City, MD, 21043, US

(21) Appl. No.: 11/011,886

(22) Filed: Dec. 13, 2004

Related U.S. Application Data
(60) Provisional application No. 60/626,346, filed on Nov. 9, 2004.

(51) Int. Cl. B01D 46/00

(52) U.S. Cl. 55/506

(57) ABSTRACT

The assembly consists of a trimming mounting plate receiving a cover and the air filters. The air filters are located between the mounting plate and the cover. The grills of the cover are utilized to hold the air filters and allow the cover to be received by the mounting plate. The mounting plate partitions the returning duct opening into identical areas. The air filter is consists of a frame and a filter media. The air filters cover the identical areas of the duct opening partitioned by the mounting plate. The air filter frame is color, alphabetical and numerical coded to indicate its size. The filter media attached to the filter frame is larger than the frame to create pockets and wrinkles for the pleated effect. The filter media is secured on the face of the frame contacting the mounting plate to create pressure and friction fit. The filter media also limit and filter the otherwise unfiltered airflow around the sides of the most filters on the market.

### BACKGROUND OF THE INVENTION

1. Field of the Invention

The present invention relates to air filters and, more particularly, for filtering air that is diverted from the return air duct of a forced air system.

2. Information Disclosure Statement

Air conditioning and air heating systems for homes and offices commonly include a number of ducts for delivery of the heated or cooled air and the return outlets of ducts of air to be heated or cooled also distributed at various locations around the home or office. Over time, dust will cumulate in the ducting system where it is generally moist, dark and maintain almost constant temperature—perfect place for moulds and other micro-organisms to grow. The collection of dust and the condensation of moist may cause erosion in the dust work system. Furthermore,, the airborne dust circulated by the system can have negative health effect.

To reduce the harm caused by this problem, various types of filter constructions have been proposed. However they all suffer from various disadvantages. For example, they may be relatively complex, expensive to manufacture, difficult to install and difficult or impossible to remove for cleaning. Or, they are large in size which cause visual displeasure, require a register and hinges which will cumulate dirt and need cleaning.

Since the great variety of sizes of return duct opening of the ducted forced air delivery System, there are filters with adjustable frames on the market. We observe the reason for the size adjustable filter is not the need of frequently adjusting the size of the filter by the user. Rather, people need a convenient system to help them memorize the size of the filter.

This invention also provide the option of disposable duct opening cover with filter when the cover and filter is combined into one body and constructed with inexpensive material.

It is to be understood that the word ‘receive’ as used throughout this document is to be interpreted as temporary and removable. It is to be understood that the word ‘attach’ and ‘fasten’ as used throughout this document is to be interpreted as permanent. It is to be understood that the word ‘comprising’ as used throughout this document is to be interpreted in its inclusive form i.e. use of the word comprising does not exclude the addition of other elements.

It is to be understood that various modifications of and/or additions to the invention can be made without departing from the basic nature of the invention. These modifications and/or additions are therefore considered to fall within the scope of the invention.

### SUMMARY OF THE INVENTION

It is, therefore, an objective of the present invention to provide an air filter assembly with the plain traditional appearance which is cheap, sturdy, easy to assemble, install and remove, and without adding new components such as hinges which collect dust and require cleaning. Consider the fact of large variety of sizes of the return duct openings, their identical partition maybe different. However, all such partitions maybe categorized in several groups. The present invention also provides a color code for the filter sizes and the alphabetical code or traditional numerical code for the convenience of color blind people. We observe the fact of most return duct opening bares only a fraction of the total airflow of a forced air conditioning system. Therefore, consider the future technology may produce very high quality thin filter the preferred embodiment of the present invention does not use the thick air filter designed for the entire system currently available on the market.

Since the size of the cover used does not have to be precisely cover the duct opening, the invention intends to eliminate of size from the duct opening cover and filter.

It is our experience that more dust may be cumulated onto the cover with a filter placed behind it than without. Therefore, this invention allows the cover to receive the filter so that it could be removed together with the filter and cleaned, Also, one would prefer to handle the filter in a place of choice when replacing the filter.

We also observe that duct systems are often located in between the studs of the walls. Therefore, the cross section area is no larger than 16 inches by 6 inches.

### DISCUSSION OF THE PRIOR ARTS

A preliminary patentability search in Class 55, subclasses 501, 496, 503, 506, 511, 516, 480, 481, 482 and digest 31, and Class 160, subclasses 372, 373 and 374, produced the following patents and patent applications, some of which may be relevant to the present invention: Weed, U.S. Pat. No. 3,675,402, issued Jul. 11, 1972; Pick, U.S. Pat. No. 5,059,218, issued Oct. 22, 1991; Nolen, Jr., U.S. Pat. No. 5,188,646, issued Feb. 23, 1993; Brown, et al. U.S. Pat. No. 5,863,310, issued Jan. 26, 1999; Sorice, et al. U.S. Pat. No. 6,030,427, issued Feb. 29, 2000; Clayton, et al. U.S. Pat. No. 6,623,540, issued Sep. 23, 2003; McNaughton, Craig Douglas U.S. Pat. No. 6,716,266, issued April 2004; Wolf, et al. U.S. Pat. No. 6,719,820, issued Apr. 13, 2004; and U.S. patent application 20040074214 by Henson Joseph C. on Apr. 22, 2004. Finally, Johnson; Ken A. U.S. Pat. No. 4,982,627, January 1991 titled Color Coaded Tools.

While each of the above patents discloses various filters and screens, none disclose or suggest the present invention. More specifically, none of the above patents disclose or suggest keeping the traditional appearances of the common return duct opening cover or partition the air passages and color-code the sizes to manage the large variety of the sizes.

Weed, U.S. Pat. No. 3,675,402 discloses a frame assembly is telescopically adjustable in two different directions and is provided with a clamp for holding the adjustment at any desired predetermined size or shape within the confines of its adjustment limits.

Pick, U.S. Pat. No. 5,059,218 discloses a construction for supporting a flexible screen or sheet such as a window screen, or the like, and its application to the assembly of an electrostatic air filter of the charged media type. The filter includes a U-shaped channel adapted to receive a spline member for frictionally engaging a flexible sheet such as a window screen.

Brown, et al. U.S. Pat. No. 5,863,310 and Sorice, et al. U.S. Pat. No. 6,030,427 uses hinges.

McNaughton, U.S. Pat. No. 6,716,266 discloses a construction of a filter formed of rubbery thermoplastics material and an integral lip of flexible resilient material extending outwardly from the body portion.

Wolf, U.S. Pat. No. 6,719,820 and Clayton, U.S. Pat. No. 6,623,540 are all for thicker filter.

Henson, U.S. patent application 20040074214, an air filter is slidably received. The slide motion may disturb the dust.

Most filters on the market are for the protection of the heating or cooling unit, responsible for the entire airflow through the unit and often almost 1-inch in thickness. The assembly according to this invention is for the duct return opening, and in most cases only filters a fraction of the total air flow. Therefore, the air filter according to this invention does not require the same standard and the same high cost of the typical thick filter designed for the entire force air system on the market.

### DISCLOSURE OF THE INVENTION

The invention provides a dust filter for a ducted air delivery system comprising:

A duct opening cover has multiple cuts to allow air flow through. The cuts also produce multiple fixed flaps which improves the visual effects; at least one of the fixed flaps is used to fold the air filter and/or to be received by the mounting plate;

a trimming mounting plate partitions the duct opening into identical areas, is fasten over the duct opening and the wall to trim the opening filter, receive the duct opening cover and may also receive the air filter;

a filter frame constructed follow the dimension of the identical partition of the duct opening by the mounting plate;

the larger filter media material than frame opening covers the opening and produce pockets and wrinkles which create the pleated effect of high performance filter design;

the filter media along the side of frame limits and filters the air flow around the edges of the filter eliminates the un-filtered air flow;

the dust filter frame include means to allow it to be hold by either the mounting plate or the return duct opening cover;

the filter media is glued onto the frame by flexible and nontoxic adhesive material;

in one form of the invention, the filter frame is made of stiff card board or plastic board;

the filter frame bare a color code, and/or alphabetical code and/or numerical code indicates its size;

preferred aspects will now be described with reference to the accompanying drawings.

### DETAILED DESCRIPTION OF THE PREFERRED EMBODIMENTS

Referring to FIG. 1 of the accompanying drawings there is shown a cover generally designated having multiple cuts 11 and a one by two square partition of 12.

Referring to FIG. 2 is a side view of the cover generally designated having four of the fixed flaps 21 produced by the cuts 13 of FIG. 1 and used for holding the air filter and being received by the mounting plate.

Referring to FIG. 3 shown a mounting plate generally designated following the partition 12 of FIG. 1; four fixed flaps 31 are used to hold the air filter and receive the cover; holes 32 are used to fasten the plate over the duct opening.

Referring to FIG. 4 is a side view of the mounting plate of FIG. 3; fixed flaps 41 are produced by 31 of FIG. 3 and used to hold the air filter and receive the cover.

Referring to FIG. 5 of the filter frame constructed with thin material following the partition of 12 of FIG. 1 has two larger sides (the front of the back, one of the two is the 51 which will be covered by the filter media.) defines an opening area 2 which will be covered by the filter media.

The frame in the drawings of this preferred embodiment is made of stiff card board or plastic board.

The cuts 61 allow the air filter to be received by either the mounting plate or the cover through the fixed flaps 21, 32 or 41; two identical air filters are needed in this drawing.

### BRIEF DESCRIPTION OF THE DRAWINGS

FIG. 1 is a cover of a filter assembly in accordance with the invention;

FIG. 2 is a cross section side view of the cover in FIG. 1;

FIG. 3 is a mounting plate in accordance with the invention;

FIG. 4 is a side view of the mounting plate in FIG. 3;

FIG. 5 is a pair of two identical air filter frame in accordance with the invention;

FIG. 6 is a pair of two identical air filters in accordance with the invention.

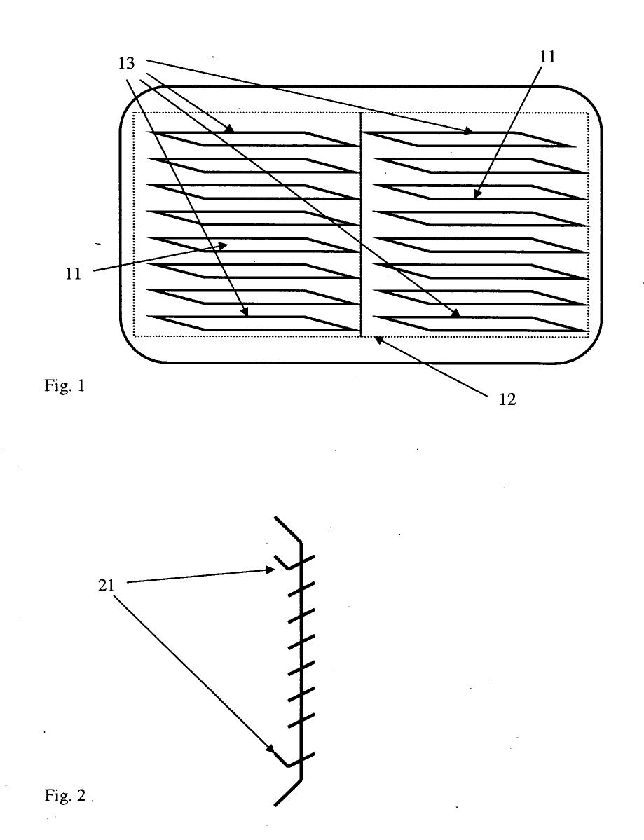

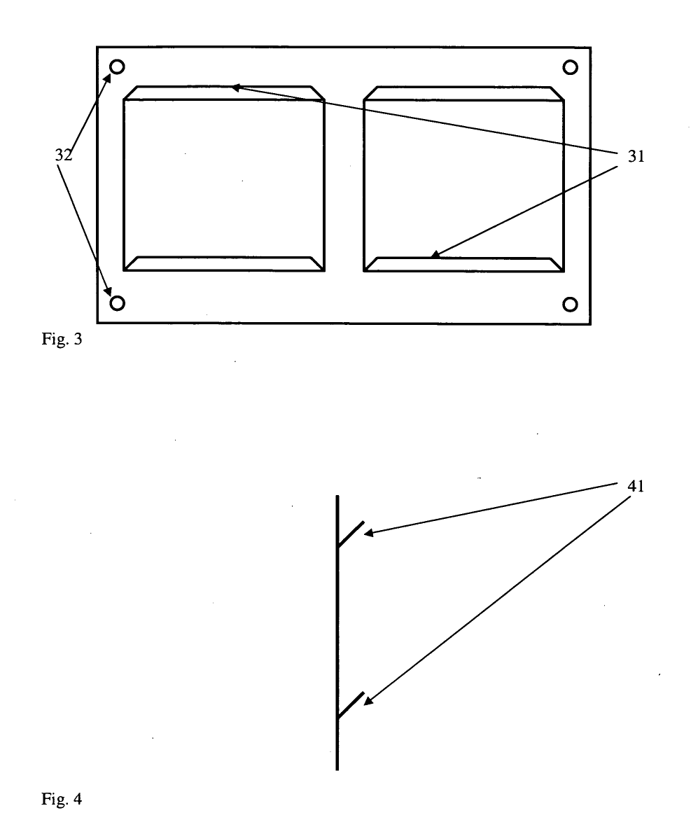

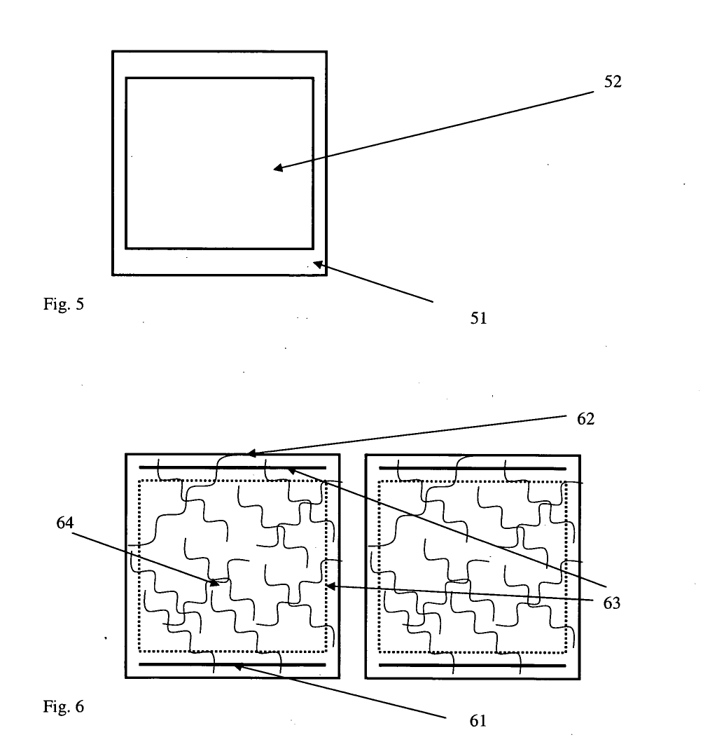

The various integers with reference to the accompanying drawings are identified in the following:

cuts 11 allow air flow through;

doted lines 12 indicate the partition defined by the two groups of cuts;

fixed flaps 21 are used to hold the air filter and receive the cover;

31 are fixed flaps to hold the air filter and receive the cover;

32 are fastener holes for attaching the mounting plate to the wall;

41 is a side view of the fixed flap 31;

51 is the front side or face of the thin air filter frame;

52 open areas defined by the thin air filter frame;

61 are the cuts to allow the fixed flaps 21 and 31 or 41 to come through to receive the air filter;

63 indicate the filter media covers the entire side of 51;

64 indicate the pockets and wrinkles created by the filter media of size larger than the area of the frame.

The claims defining the invention for the air returning duct opening of a ducted forced air delivery system are as follows:

1. An air filtration assembly, air filtration applications comprising
(a) air filters consists of filter frame and filter media;
(b) a mounting plate to be fasten over the duct opening, have means to receive said air filters and a duct opening cover;
(c) said duct opening cover is received by said mounting plate and have means of receiving said air filter,
said assembly including:

2. An air filtration assembly according to claim 1, wherein said duct opening cover is constructed by rigid material and have multiple cuts, said cuts are air passages, said cover receives said air filters and is received by said mounting plate,
(a) means of utilizing said cuts of said duct opening cover to receive said air filter according to claim 1;
(b) means of utilizing said cuts of said duct opening cover to be received by said mounting plate according to claim 1.

3. An air filtration assembly according to claim 1, wherein said mounting plate is constructed by rigid material; said mounting plate partitions said duct opening into one or more identical sections which define one or more air passages; said mounting plate is fasten over said duct opening; said mounting plate receives said filter and said duct opening cover according to claim 1,
(a) means to fasten said mounting plate over said duct opening;
(b) means for said mounting plate to receive said air filter according to claim 1;
(c) means for said mounting plate to receive said duct opening cover according to claim 1.

4. An air filtration assembly according to claim 1, wherein said air filter media is attached to said filter frame to form said air filter; one or more copies of said air filter maybe needed to cover all said air passages according to claim 3;
(a) said filter frame has a color coded means to identify its size;
(b) said filter frame is constructed following the dimensions of said identical sections according to claim 3 of said mounting plate according to claim 1 and form a peripheral frame which define the filter frame open area to be covered by said filter media according to claim 1;
(c) said air filter media have a surface area greater than that of said filter frame open area to create pockets and the pleated effect; said air filter media to be attached onto said frame and to cover the entire said open area of said filter frame;
(d) means to attach said filter media to said frame and said filter media covers the entire one of the two larger sides of said frame;
(e) means for said air filter media to be received by either said mounting plate or said cover.
